(19) United States
(12) Patent Application Publication
(10) Pub. No.: US 2026/0057298 A1
(43) Pub. Date: Feb. 26, 2026

(54) INFORMATION PROCESSING APPARATUS, INFORMATION PROCESSING METHOD, AND STORAGE MEDIUM

(71) Applicant: HONDA MOTOR CO., LTD., Tokyo (JP)

(72) Inventors: Kosuke NAKANISHI, Wako-shi (JP); Shin ISHII, Sakyo-ku (JP); Akihiro KUBO, Sakyo-ku (JP)

(21) Appl. No.: 19/291,522

(22) Filed: Aug. 5, 2025

(30) Foreign Application Priority Data
Aug. 23, 2024 (JP) 2024-143317

(51) Int. Cl. G06N 20/00

(52) U.S. Cl. CPC G06N 20/00

(57) ABSTRACT

An information processing apparatus determines a distribution of adversarial noise for a model to be processed using a predetermined prior distribution; and trains at least one of an action value function or a policy function of the model to be processed based on an action value of an action in a perturbed state obtained by adding the adversarial noise to a state in an environment used in the model to be processed. The apparatus determines the distribution of the adversarial noise that reduces the action value of the model to be processed under a constraint using a divergence indicating closeness between the distribution of the adversarial noise and the predetermined prior distribution.

### CROSS-REFERENCE TO RELATED APPLICATION(S)

This application claims priority to and the benefit of Japanese Patent Application 2024-143317, filed Aug. 23, 2024, the entire disclosure of which is incorporated herein by reference.

### BACKGROUND OF THE INVENTION

### Field of the Invention

The present invention relates to an information processing apparatus, an information processing method and a storage medium.

### Description of the Related Art

It is known that a reinforcement learning algorithm may fail to perform well when a state or environment to be actually acquired changes with respect to an assumed state or environment (for example, at the time of learning). Therefore, there is proposed a reinforcement learning system that generates a new state by adding noise to an acquired state and calculates an action value function using the state in which the noise is added, thereby being able to consider variations of the state (International Publication No. 2023/037504).

It is necessary to add appropriate noise in order to evaluate robustness of a model and train the model so as to ensure the robustness. This is because there is often a trade off between ensuring robustness and performance of a controller during a normal operation, and preparation for noise that cannot occur in reality and ensuring excessive robustness lead to performance degradation in vain.

However, in the above-described related art, it is merely considered to add noise of a random number to a state.

### SUMMARY OF THE INVENTION

The present invention has been made in view of the above problems, and an object thereof is to provide a technique capable of evaluating or training a model using appropriate noise for ensuring robustness of the model.

In order to solve this problem, for example, an information processing apparatus according to the present invention is an information processing apparatus comprising: one or more processors; and a memory storing instructions which, when the instructions are executed by the one or more processors, cause the information processing apparatus to: determine a distribution of adversarial noise for a model to be processed using a predetermined prior distribution; and train at least one of an action value function or a policy function of the model to be processed based on an action value of an action in a perturbed state obtained by adding the adversarial noise to a state in an environment used in the model to be processed, wherein the instructions causing the information processing apparatus to determine the distribution of adversarial noise include the instructions causing the information processing apparatus to determine the distribution of the adversarial noise that reduces the action value of the model to be processed under a constraint using a divergence indicating closeness between the distribution of the adversarial noise and the predetermined prior distribution.

In order to solve this problem, for example, an information processing method of the present invention is an information processing method in which each step is executed by an information processing apparatus, the information processing method comprising: determining a distribution of adversarial noise for a model to be processed using a predetermined prior distribution; and training at least one of an action value function or a policy function of the model to be processed based on an action value of an action in a perturbed state obtained by adding the adversarial noise to a state in an environment used in the model to be processed, wherein the determining the distribution of the adversarial noise includes determining the distribution of the adversarial noise that reduces the action value of the model to be processed under a constraint using a divergence indicating closeness between the distribution of the adversarial noise and the predetermined prior distribution.

In order to solve this problem, for example, a non-transitory computer readable storage medium of the present invention is a non-transitory computer readable storage medium storing a program for causing a computer to execute an information processing method, the information processing method comprising: determining a distribution of adversarial noise for a model to be processed using a predetermined prior distribution; and training at least one of an action value function or a policy function of the model to be processed based on an action value of an action in a perturbed state obtained by adding the adversarial noise to a state in an environment used in the model to be processed, wherein the determining the distribution of the adversarial noise includes determining the distribution of the adversarial noise that reduces the action value of the model to be processed under a constraint using a divergence indicating closeness between the distribution of the adversarial noise and the predetermined prior distribution.

According to the present invention, it is possible to provide the technique capable of evaluating or training a model using appropriate noise for ensuring robustness of the model.

### BRIEF DESCRIPTION OF THE DRAWINGS

FIG. 1 is a block diagram illustrating a functional configuration example of a vehicle according to a first embodiment;

FIG. 2 is a view for describing a relationship between functional configurations in robustness evaluation according to the first embodiment;

FIG. 3 is a view for describing evaluation of a reinforcement learning model according to the first embodiment;

FIG. 4A is a view for describing details of noise addition according to the first embodiment;

FIG. 4B is a view for describing a noise distribution generated according to the first embodiment;

FIG. 5 is a flowchart illustrating a series of operations of noise addition processing according to the first embodiment;

FIG. 6 is a flowchart illustrating a series of operations of robustness evaluation processing according to the first embodiment;

FIG. 7 is a diagram for describing a main configuration of a vehicle according to a second embodiment;

FIG. 8 is a view for describing a learning method of a reinforcement learning model according to the second embodiment;

FIG. 9 is a flowchart illustrating a series of operations of model learning processing according to the second embodiment;

FIG. 10 is a view for describing evaluation of a reinforcement learning model according to a third embodiment;

FIG. 11 is a view for describing processing for changing an environment according to the third embodiment; and

FIG. 12 is a flowchart illustrating a series of operations of robustness evaluation processing according to the third embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

In a first embodiment, robustness evaluation according to the present embodiment will be described. In the robustness evaluation described here, whether a machine learning model to be evaluated has robustness with respect to an input including noise is evaluated. Therefore, in the present embodiment, appropriate noise is added to perform such robustness evaluation. Note that a case where the present invention is implemented on a vehicle will be described as an example in embodiments described below. However, the embodiments described below may be executed in one or more information processing apparatuses such as a server apparatus. In addition, the vehicle described below includes a four-wheeled or two-wheeled passenger vehicle, and also includes a vehicle that guides a person or moves to a person without any person getting on the vehicle. Further, the embodiments described below can also be applied to a robot that can move autonomously or according to an operation, in addition to the above-described vehicle. The embodiments described below are not limited to an apparatus that can move by itself, and is also applicable to a robot that moves an object (for example, a robot arm) and an information processing apparatus (control apparatus) that directly or remotely controls a movable apparatus.

### <Vehicle Configuration>

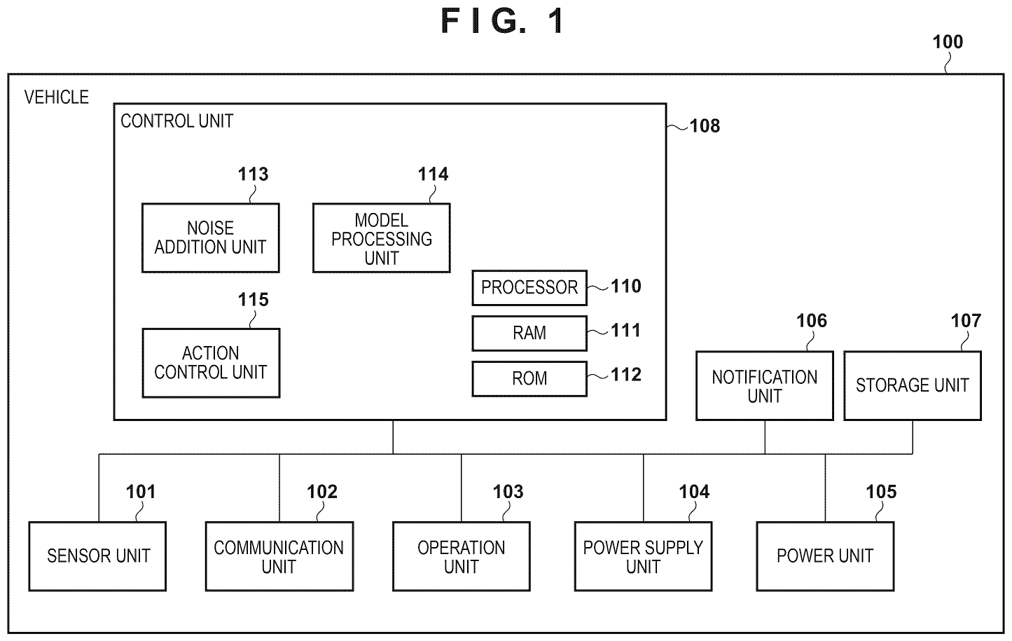

First, a functional configuration example of a vehicle 100 according to the present embodiment will be described with reference to FIG. 1. Note that each of functional blocks to be described with reference to the following drawings may be integrated or may be separated. In addition, a function to be described may be implemented in another block. In addition, a functional block described as hardware may be implemented by software, and vice versa.

In the following example, a case where a control unit 108 is incorporated in the vehicle 100 will be described as an example, and the control unit 108 of the vehicle 100 may be configured as a control module or an information processing apparatus including a configuration of the control unit 108. That is, the present invention can be implemented as a control module or an information processing apparatus including configurations such as a processor 110 and a model processing unit 114 included in the control unit 108.

A sensor unit 101 includes various sensors provided in the vehicle 100, and outputs sensor data regarding a behavior of the vehicle 100. The various sensors include, for example, a vehicle speed sensor for measuring a vehicle speed of the vehicle 100, an acceleration sensor for measuring a body acceleration of the vehicle, and a suspension displacement sensor for measuring a stroke behavior (speed or displacement) of a damper. In addition, a steering angle sensor that measures a steering input, a sensor that measures a torque generated by a power unit 105, a GPS that acquires a self-location, and the like are included. Further, the sensor unit 101 may include a camera (an image capturing unit) that outputs a captured image of a view in front of the vehicle 100 (or views in front of, beside, and behind the vehicle). The sensor unit 101 may further include a light detection and ranging (LiDAR) that outputs a range image obtained by measuring a distance to an object in front of the vehicle (or distances to objects in front of, beside, and behind the vehicle).

One or more of pieces of the sensor data such as an acceleration, position information, a steering angle, a torque, a captured image, and the range image of the vehicle 100 are used as one of states for controlling an action of the vehicle by a reinforcement learning model included in the model processing unit 114, for example.

A communication unit 102 is a communication device including, for example, a communication circuit, and communicates with an external information processing server, a transportation system located around the vehicle, and the like through, for example, Long Term Evolution (LTE), LTE-Advanced, or mobile communication standardized as the so-called fifth generation mobile communication system (5G). For example, the communication unit 102 receives a part or all of map data, traffic information, and the like from another information processing server or the transportation system located around the vehicle. The communication unit 102 may acquire, from the external information processing server, at least any of a hyperparameter of a learning model used by the model processing unit 114, a learned parameter, a prior distribution of noise and a prior distribution of an environmental parameter to be described later, or the like.

An operation unit 103 includes an operation member such as a button or a touch panel installed in the vehicle 100 and members that receive input for driving the vehicle 100, such as a steering wheel and a brake pedal. A power supply unit 104 includes a battery including, for example, a lithium-ion battery, and supplies electric power to each unit in the vehicle 100. The power unit 105 includes, for example, an engine or a motor that generates power for causing the vehicle to travel. A notification unit 106 notifies an occupant (or a driver) of a predetermined sound such as a warning sound.

A storage unit 107 includes a nonvolatile large-capacity storage device such as a semiconductor memory. Various types of sensor data output from the sensor unit 101 are temporarily stored. In addition, a learned parameter of a machine learning model executed by the model processing unit 114 and information of a trajectory including a set of actions and states of reinforcement learning to be described later are stored.

The control unit 108 includes, for example, the processor 110, a random access memory (RAM) 111, and a read-only memory (ROM) 112, and controls operation of each unit of the vehicle 100. In addition, the control unit 108 can acquire sensor data from the sensor unit 101 and execute a process of controlling an action of the vehicle 100 by the reinforcement learning model to be described later and a process of evaluating robustness of the reinforcement learning model. The control unit 108 causes each unit such as the model processing unit 114 included in the control unit 108 to fulfill its function by causing the processor 110 to deploy a computer program stored in the ROM 112 to the RAM 111 and to execute the computer program.

The processor 110 includes one or more processors such as a CPU. In addition to the CPU, the processor 110 may include other processors or circuits such as a graphics processing unit (GPU) and an application specific integrated circuit (ASIC) for executing processing of the model processing unit 114 at a high speed. The RAM 111 includes a volatile storage medium such as a dynamic RAM (DRAM), and functions as a working memory of the processor 110. The ROM 112 includes a nonvolatile storage medium, and stores a computer program to be executed by the processor 110, a setting value to be used when the control unit 108 is operated, and the like.

A noise addition unit 113 generates adversarial noise and adds the generated adversarial noise to the sensor data (for example, torque or captured image) received from the sensor unit 101. The adversarial noise may be referred to as an adversarial sample or the like. The adversarial noise is obtained by identifying an input for which a trained model cannot output an optimal result or an evaluation value to be predicted is low (performance is low). As the adversarial noise is added to the model, robustness of the model can be evaluated, or the model can be trained so as to be more robust. Note that the noise addition using the noise addition unit 113 is executed when robustness of a machine learning model of the model processing unit 114 is evaluated or the machine learning model is trained. That is, the noise addition unit 113 is not used in traveling of the vehicle 100 not involving the evaluation of the machine learning model. In this case, the sensor data output from the sensor unit 101 may be input to the model processing unit 114.

The model processing unit 114 executes a machine learning model that implements a reinforcement learning algorithm, and determines an action of the vehicle 100 using the sensor data. For example, an action instruction for controlling the power unit 105 (so as to control acceleration/deceleration or steering) is output using the sensor data such as the torque or the captured image. Note that this control example is an example, and any action instruction may be output using any sensor data.

An action control unit 115 controls traveling of vehicle 100 based on the action instruction output from the model processing unit 114. For example, the action control unit 115 controls the power unit 105 in accordance with the action instruction for controlling the power unit 105 by the model processing unit 114. Although the model processing unit 114 and the action control unit 115 are described separately in the present embodiment, the action control unit 115 may be included in the model processing unit 114.

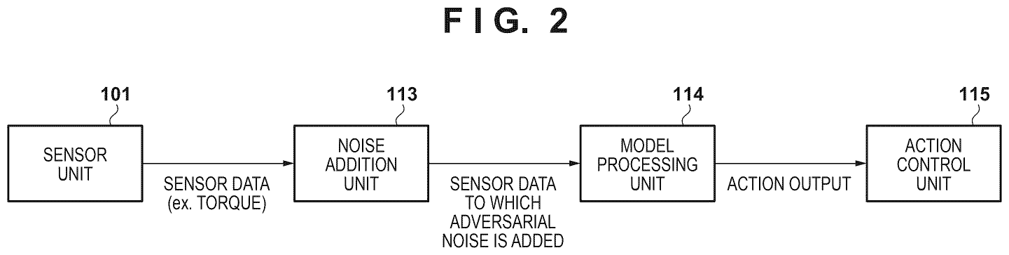

FIG. 2 illustrates a relationship between main functional configurations in the robustness evaluation according to the first embodiment. For example, the sensor unit 101 acquires sensor data (for example, torque). The noise addition unit 113 adds adversarial noise to be described later to the sensor data. The model processing unit 114 determines an action output (for example, a control amount of acceleration/deceleration or steering) corresponding to an action to be taken by the vehicle 100 using the sensor data in which the adversarial noise is added. The action control unit 115 controls the power unit 105 in accordance with the action output from the model processing unit 114.

### <Evaluation of Reinforcement Learning Model>

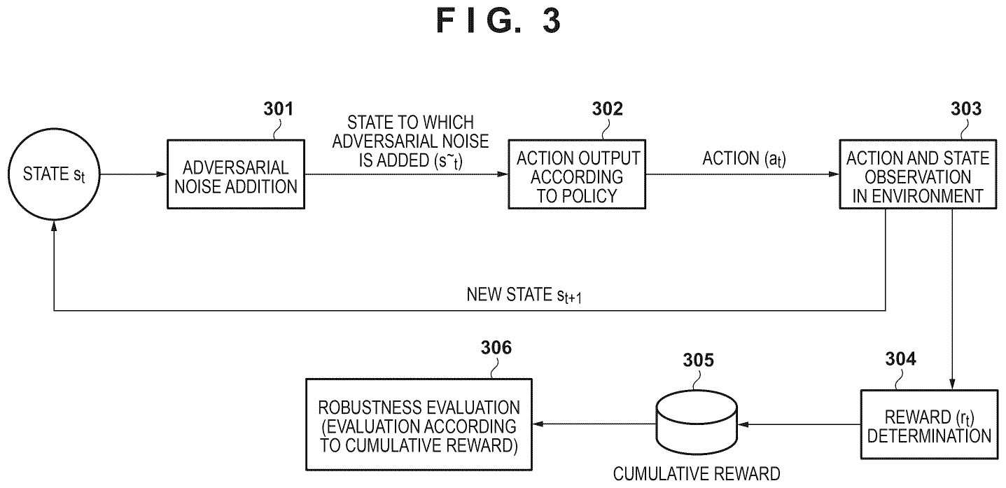

Next, evaluation of a reinforcement learning model according to the present embodiment will be described with reference to FIG. 3. At certain time t, sensor data is acquired. When the sensor data is acquired, as described above, the noise addition unit 113 adds adversarial noise to be described later to the sensor data (adversarial noise addition 301). The model processing unit 114 receives the sensor data to which the adversarial noise is added, and outputs a control amount that has been obtained (by execution of a machine learning algorithm) (action output according to policy 302). At this time, in reinforcement learning, the sensor data corresponds to a state (sₜ) of an environment, and the control amount corresponds to an action (aₜ) with respect to the environment. In addition, the adversarial noise is added to the state (sₜ) to obtain a state (s^{˜}ₜ) in which adversarial noise is added.

Thereafter, when the action control unit 115 controls the power unit 105 based on the control amount, new sensor data is acquired at time t+1 (action and state observation in environment 303). In the reinforcement learning, this sensor data corresponds to a state (sₜ₊₁) in the environment. The model processing unit 114 determines a reward (rₜ) (or penalty) in the reinforcement learning based on the sensor data from the sensor unit 101 (reward determination 304). The reward is, for example, a reward value regarding a behavior of the vehicle obtained from a combination of pieces of predetermined sensor data. As time passes, processing from 301 to 304 is repeated, and a reward for an action over a plurality of steps is accumulated (cumulative reward 305). For example, the model processing unit 114 compares a cumulative reward obtained in a case where no adversarial noise is added with the cumulative reward 305, and evaluates robustness with respect to the model (robustness evaluation 306). For example, in a case where the cumulative reward 305 has changed by a predetermined value or more from the cumulative reward obtained in the case where no adversarial noise is added, it means that an action of the model deviates from an originally expected action, which indicates that the robustness against the adversarial noise is low.

The model processing unit 114 operates, for example, a reinforcement learning model constituting Actor-Critic. An actor selects an action (a) based on a policy π(a|s). A critic is a mechanism for evaluating the policy π(a|s) currently used by the actor, and has an action value function Q^{π}(s, a) representing a discount reward sum expected when an action a is taken in a state s, for example, under a policy x. Note that, in Actor-Critic, the critic for evaluating a policy is simultaneously trained while improving the actor for determining an action as will be described later. However, a method other than Actor-Critic, such as Q-learning or DON, can be similarly used considering that the actor selects one having the largest evaluation value (the largest value of the action value function) among a plurality of action candidates even for a method in which an action output is discrete and an optimal action is selected from among the plurality of action candidates.

### <Details of Noise Addition>

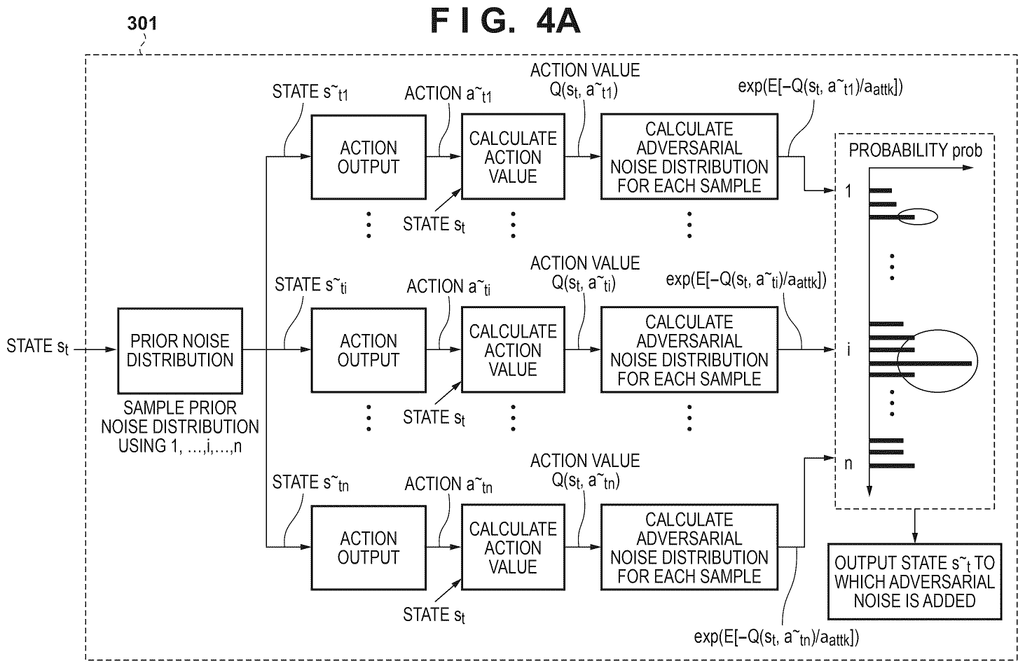

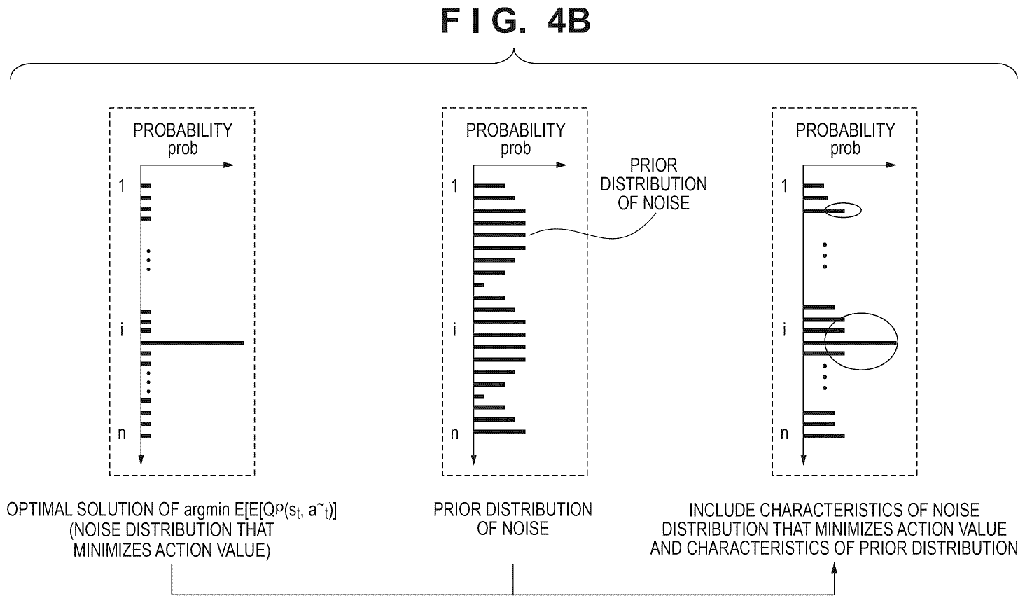

Next, details of the noise addition according to the present embodiment will be described with reference to FIG. 4A. This processing is performed in the noise addition unit 113 for a state sₜ acquired at time t. The noise addition unit 113 acquires a prior distribution of noise described below from the storage unit 107 or the communication unit 102.

For example, in a case where approximation is performed by sampling, the noise addition unit 113 performs sampling of noise according to a predetermined prior distribution into n pieces of data. The prior distribution may be various distributions assuming a noise distribution that can occur in an environment used in a model to be evaluated, and various distributions can be used in addition to a normal distribution.

The noise addition unit 113 adds each sampled noise to the state sₜ to generate perturbed states (s^{˜}ₜ₁, . . . , s^{˜}ₜᵢ, . . . , and s^{˜}ₜₙ). Note that a superscript “˜” indicates a value perturbed by the influence of noise. After calculating actions a ti in the perturbed states (using the actor), the noise addition unit 113 calculates action values Q(sₜ, a^{˜}ₜᵢ) of the actions in a case where the actions a^{˜}ₜᵢ are taken in the state sₜ (using the critic).

The noise addition unit 113 calculates an adversarial noise distribution for the model (reinforcement learning model) to be evaluated. The distribution of the adversarial noise is obtained by obtaining a distribution of noise that minimizes an action value of the model (that is, noise that makes the model weakest) while adding a constraint using a divergence representing the closeness between the calculated adversarial noise distribution and the predetermined prior distribution. An adversarial noise distribution v*(s^{˜}ₜ|sₜ) that minimizes an action value in the state s t is obtained by the following Formula (1) when the divergence is an f-divergence.

$$[ MATH . 1 ]$$

$${v}_{π}^{*} ( {s}_{t}^{\sim} \vert {s}_{t} ) = {arg min}_{v ∈ N} {E}_{{s}_{t}^{\sim} ∼ v} [ {E}_{{a}_{t}^{\sim} ∼ π ( \cdot \vert {s}_{t}^{\sim} )} [ {Q}^{{π}^{\sim}} ( {s}_{t} , {a}_{t}^{\sim} ) ] ] + {α}_{attk} {D}_{f} ( v ( \cdot \vert {s}_{t} ) ‖ p ( \cdot \vert {s}_{t} ) ) \qquad ( 1 )$$

Here, D_{f}(v∥p) is the f-divergence between a distribution v and a noise prior distribution p, and αₐₜₜₖ is an adjustment factor for adjusting the strength of the constraint by the divergence. That is, in Formula (1), how much the noise distribution v is constrained by the prior distribution p can be adjusted by αₐₜₜₖ when the noise distribution that minimizes an expected value of an action value Q^{π˜}(sₜ, a^{˜}ₜ) of an action in a case where the action a^{˜}ₜ is taken in the state sₜ is obtained.

As a value of αₐₜₜₖ is closer to 0, the distribution of v*(s^{˜}ₜ|sₜ) can approach a spike-like distribution having a peak at one noise value that minimizes the action value, as an example. On the other hand, as the value of αₐₜₜₖ is larger, the distribution of v*(s^{˜}ₜ|sₜ) closer to the distribution of the prior distribution p is generated. That is, in the present embodiment, if the value of αₐₜₜₖ is appropriately set, it is possible to obtain the adversarial noise distribution adjusted to have characteristics of the prior distribution p while including characteristics of the noise distribution (that minimizes the action value).

Next, when the divergence is assumed to be Kullback-Leibler (KL) divergence, an analytical solution of the minimized adversarial noise distribution v*(s^{˜}ₜ|sₜ) of Formula (1) can be expressed by Formula (2) by using the Legendre-Fenchel transform. However, in a case where a continuous state space and a continuous action space are handled, computation is difficult, and even if approximation is performed by a known method such as a Markov chain Monte Carlo method, it is necessary to access the policy π and the action value function Q^{π} a plurality of times for calculating a value every time t, so that there is a problem that calculation cost is high.

$$[ MATH . 2 ]$$

$${v}_{π}^{*} ( {s}_{t}^{\sim} \vert {s}_{t} ) = \frac{p ( {s}_{t}^{\sim} \vert {s}_{t} ) exp ( {E}_{{a}_{t}^{\sim} ∼ π ( \cdot \vert {s}_{t}^{\sim} )} [ - {Q}^{π} ( {s}_{t} , {a}_{t}^{\sim} ) / {α}_{attk} ] )}{{\int }_{{s}_{t}^{\sim}} p ( {s}_{t}^{\sim} \vert {s}_{t} ) exp ( {E}_{{a}_{t}^{\sim} ∼ π ( \cdot \vert {s}_{t}^{\sim} )} [ - {Q}^{π} ( {s}_{t} , {a}_{t}^{\sim} ) / {α}_{attk} ] ) {ds}_{t}^{\sim}} \qquad ( 2 )$$

Therefore, as one of the present embodiments, an approximate adversarial noise distribution v*(s^{˜}ₜ|sₜ) is obtained by Formula (3) by approximating Formula (2) using a limited number (for example, 1 to n described in FIG. 4A) of sample values of a prior distribution p(s^{˜}ₜ|sₜ) of noise.

$$[ MATH . 3 ]$$

$${v}_{π}^{*} ( {s}_{t}^{\sim} \vert {s}_{t} ) ≅ {v}_{π}^{*} ( {s}_{ti}^{\sim} \vert {s}_{t} ) ∝ exp ( {E}_{{a}_{ti}^{\sim} ∼ π ( \cdot \vert {s}_{ti}^{\sim} )} [ \frac{- {Q}^{π} ( {s}_{t} , {a}_{ti}^{\sim} )}{{α}_{attk}} ] ) \qquad ( 3 )$$

This is obtained by subtracting the term p from the numerator on the right side of Formula (2) in order to correct a weight for each sample according to the prior distribution p(s^{˜}ₜ|sₜ) used for sampling from the prior distribution to the adversarial noise distribution. In addition, this corresponds to calculating the action values Q(sₜ, a^{˜}ₜᵢ) corresponding to the samples illustrated in FIG. 4A and then calculating the adversarial noise distribution for the samples. Specifically, the adversarial noise distribution is obtained by calculating an exponential function using an expected value with respect to a ratio between the action value Q(sₜ, a^{˜}ₜᵢ) and a value of the adjustment factor αₐₜₜₖ.

In addition, a method of separately preparing a model v^{model}_{π}(s^{˜}ₜ|sₜ) for generating adversarial noise and training the model in parallel with learning of Actor-Critic so as to have the same distribution of Formula (2) is considered as a method different from the sample approximation. This can be easily obtained, for example, by updating the adversarial noise model so as to minimize Formula (4) based on the noise distribution generated by the model and the KL divergence of Formula (2).

$$[ MATH . 4 ]$$

$$Loss = {E}_{{s}_{t} ∼ D ( \cdot )} [ {D}_{KL} ( {v}_{π}^{model} ( \cdot \vert {s}_{t} ) \vert \frac{p ( \cdot \vert {s}_{t} ) exp ( {E}_{{a}_{t}^{\sim} ∼ π ( \cdot \vert {s}_{t}^{\sim} )} ( \frac{- {Q}^{π} ( {s}_{t} , {a}_{t}^{\sim} )}{{α}_{attk}} ] )}{Z} ) ] ∝ {E}_{{s}_{t} ∼ D ( \cdot )} [ {E}_{{s}_{t}^{\sim} \sim {v}_{π}^{model ( \cdot \vert {s}_{t} )}} [ \text{} {α}_{attk} log {v}_{π}^{model} ( {s}_{t}^{\sim} \vert {s}_{t} ) - {α}_{attk} log p ( {s}_{t}^{\sim} \vert {s}_{t} ) + {E}_{{a}_{t}^{\sim} ∼ π ( \cdot \vert {s}_{t}^{\sim} )} [ {Q}^{π} ( {s}_{t} , {a}_{t}^{\sim} ) ] + const . ] ] \qquad ( 4 )$$

Here, sₜ˜D(⋅) means that a plurality of trajectories are extracted from the storage unit 107 by the size of a batch to calculate an expected value. Z represents the denominator (distribution function) on the right side of Formula (2) and this term does not depend on s^{˜}ₜ (is integrated out), and thus, does not contribute to learning of the adversarial noise distribution as a constant term const., and can be ignored.

FIG. 4B schematically illustrates a noise distribution generated by the noise addition unit 113. The noise distribution obtained by Formula (3) is a distribution (right in FIG. 4B) in which the characteristics of the noise distribution (left in FIG. 4B) that minimizes the action value and the characteristics of the prior distribution (center in FIG. 4B) are added. Note that, in the example illustrated in FIG. 4B, a sample corresponding to a peak of the distribution illustrated on the right of FIG. 4B corresponds to a sample indicating a peak in the noise distribution that minimizes the action value. That is, noise at the peak of the distribution obtained by Formula (3) corresponds to noise that minimizes the action value. However, there is a case where the distribution obtained by Formula (3) does not include noise that minimizes the action value depending on how to take samples such as reducing the number n of samples. Instead, the peak of the distribution obtained by Formula (3) can be noise according to the prior distribution around the noise that minimizes the action value or away from the noise.

In the present embodiment, since the approximate adversarial noise distribution v*(s^{˜}ₜ|sₜ) according to Formula (3) is calculated based on the action value Q(sₜ, a^{˜}ₜᵢ) corresponding to the noise obtained by sampling the prior distribution or the adversarial noise model trained in advance according to Formula (4) is used for the calculation, it is not necessary to perform optimization calculation to obtain the minimum value of the action value Q(sₜ, a^{˜}ₜ) using a gradient method or the like. Since the optimization calculation using the gradient method that requires a large calculation cost becomes unnecessary, the calculation cost can be greatly reduced, and the processing speed can be increased.

The noise addition unit 113 selects (for example, the most adversarial) noise from the obtained adversarial noise distribution, adds the noise to the state sₜ, and outputs as the state s^{˜}ₜ in which the adversarial noise is added. In this manner, it is possible to generate reasonable noise that lowers the action value of the model while following the noise distribution assumed in advance. In other words, it is possible to add appropriate noise by selecting a sample that is adequately weak at the noise distribution assumed in advance for evaluating the robustness of the model.

In addition, in a case where the approximation by sampling is performed in the present embodiment, if the number n of samples for sampling noise of a prior distribution is increased, there is a high possibility of obtaining the most adversarial noise that minimizes an action value of a model (makes the model weakest). On the other hand, when the number n of samples is small, the possibility of including the most adversarial noise decreases, and the possibility of obtaining noise according to the characteristics of the prior distribution increases. That is, when the occurrence frequency of the most adversarial noise is extremely low, a user can perform reasonable model evaluation by adjusting the number of samples according to the evaluation purpose. Even when the occurrence frequency of the most adversarial noise is extremely low, a model is evaluated by sufficiently increasing the number of samples in a case where the evaluation of robustness of the model using the noise is required. On the other hand, in a case where it is sufficient to perform evaluation using noise according to the characteristics of the prior distribution and the evaluation for noise whose occurrence frequency is extremely low is not necessarily required, a model can be evaluated within a reasonable noise range by reducing the number of samples. Of course, in this case, the model evaluation can be performed at high speed.

### <Operation of Noise Addition Processing>

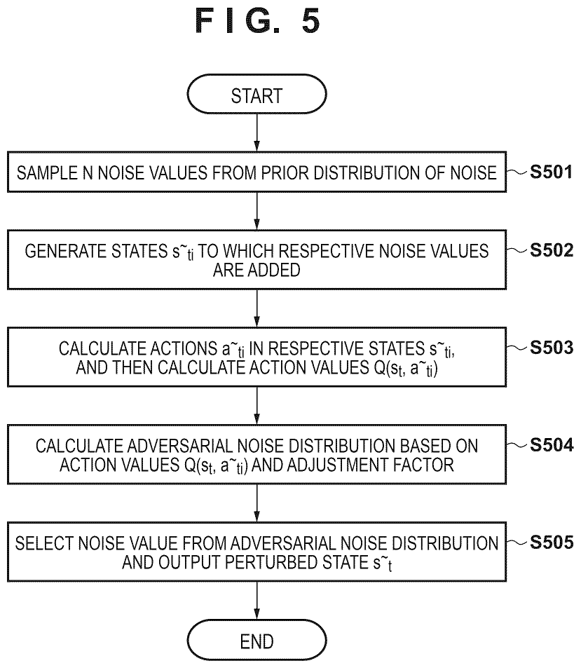

A series of operations of noise addition processing using the approximation by sampling in the noise addition unit 113 will be described with reference to FIG. 5. Note that the noise addition processing is implemented, for example, by the processor 110 deploying a computer program stored in the ROM 112 or the storage unit 107 to the RAM 111 and executing the computer program. Unless otherwise specified, the following processing is started when the noise addition unit 113 operates as a processing entity and the state sₜ of an environment used in a target reinforcement learning model is acquired from the sensor unit 101 at time t.

In S501, the noise addition unit 113 samples n noise values from a prior distribution of noise. In S502, the noise addition unit 113 generates states s^{˜}ₜᵢ to which the respective noise values are added. That is, the noise addition unit 113 adds each sampled noise to the state sₜ to generate perturbed states (s^{˜}ₜ₁, . . . , s^{˜}ₜᵢ, . . . , and s^{˜}ₜₙ).

In S503, the noise addition unit 113 calculates the actions a^{˜}ₜᵢ in the respective states s ti, and then calculates the action values Q(sₜ, a^{˜}ₜᵢ) of the actions in a case where the actions a^{˜}ₜᵢ are taken in the state sₜ.

In S504, the noise addition unit 113 calculates an adversarial noise distribution based on the action values Q(sₜ, a^{˜}ₜᵢ) and a value of the adjustment factor αₐₜₜₖ. At this time, the noise addition unit 113 calculates the approximate adversarial noise distribution v*(s^{˜}ₜ|sₜ) according to Formula (3) in a case where a divergence is the KL divergence.

In S505, the noise addition unit 113 selects a noise value according to a probability weight represented by Formula (3) of the weight of the adversarial noise distribution, and outputs the perturbed state s^{˜}ₜ obtained by adding the noise value to the state sₜ. Thereafter, the noise addition unit 113 terminates the series of operations. Here, in a case of αₐₜₜₖ→0, it corresponds to selecting (the most adversarial and weakest) noise value with the lowest action value Q(sₜ, a^{˜}ₜᵢ), and in a case where αₐₜₜₖ is sufficiently large (αₐₜₜₖ→∞), the contribution of the action value is little in Formula (3), and noise according to the prior distribution p is obtained. In this manner, it is possible to continuously adjust any degree of weakness of a sample to be selected and evaluated with high probability in accordance with αₐₜₜₖ.

### <Operation of Robustness Evaluation Processing>

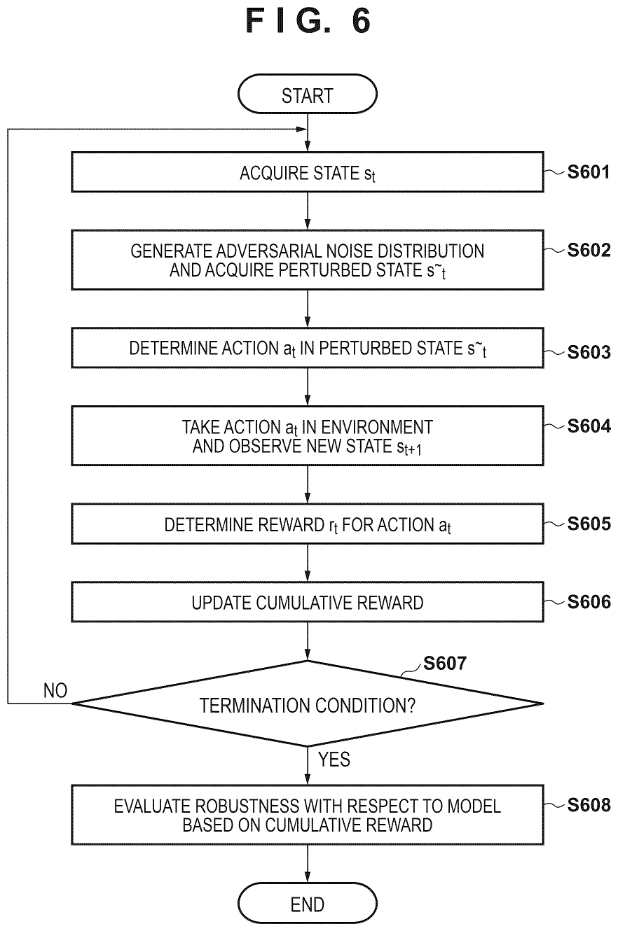

Next, a series of operations of robustness evaluation processing will be described with reference to FIG. 6. Note that this processing is implemented, for example, by the processor 110 deploying a computer program stored in the ROM 112 or the storage unit 107 to the RAM 111 and executing the computer program. The model processing unit 114 performs the following processing as a processing entity unless otherwise specified.

In S601, the control unit 108 acquires sensor data from the sensor unit 101 at time t and acquires the state sₜ of an environment used in a target reinforcement learning model.

In S602, the noise addition unit 113 executes the above-described noise addition processing to generate an adversarial noise distribution and acquire the perturbed state s^{˜}ₜ.

In S603, the model processing unit 114 determines the action at in the perturbed state s t according to, for example, the policy x of the actor. In S604, the model processing unit 114 takes the action at in the environment (for example, outputs a control amount corresponding to the action at), and acquires a new state sₜ₊₁ (for example, sensor data from the sensor unit 101).

The model processing unit 114 determines a reward rₜ for the action at in S605, and updates a cumulative reward in S606. In S607, the model processing unit 114 determines whether a termination condition is satisfied, advances the processing to S608 if the termination condition is satisfied, and returns the processing to S601 to repeat the processing if not. When repeating the processing, the model processing unit 114 advances the time from t to t+1. The termination condition may be any condition, but may be, for example, a case where the time t exceeds a predetermined time T or the like.

In S608, for example, the model processing unit 114 compares a cumulative reward obtained in a case where no adversarial noise is added with the cumulative reward in S606, and evaluates robustness with respect to the model. As described above, for example, in a case where the cumulative reward in S606 has changed by a predetermined value or more as compared with the cumulative reward in the case where no adversarial noise is added, it is determined that the robustness against the adversarial noise is low. Thereafter, the model processing unit 114 terminates the present processing.

Note that a case where the number n of samples is given in advance has been described as an example in the above description, but a setting unit that sets the number of samples may be provided such that the user can set the number of samples according to evaluation.

As described above, in the present embodiment, the control unit 108 acquires noise according to the predetermined prior distribution, adds the noise to the state in the environment used in the model to be evaluated, and calculates the action value of the action in the perturbed state. Then, the control unit 108 can approximate and generate the distribution of an adversarial noise determined based on the action value by sampling or training an adversarial perturbation model while adding the constraint using the divergence indicating the closeness between the adversarial noise distribution and the predetermined prior distribution for the model to be evaluated. In this manner, it is possible to generate reasonable noise that lowers the action value of the model while following the noise distribution assumed in advance. In other words, the model can be evaluated using appropriate noise for ensuring the performance and the robustness of the model.

### Second Embodiment

Next, a second embodiment will be described. In the second embodiment, an example in which a model is trained using an adversarial noise distribution described in the first embodiment will be described. By training the model using adversarial noise described in the first embodiment, robustness of the trained model can be improved. Note that, in the second embodiment, a configuration of a vehicle and other processing are substantially the same as those in the first embodiment except that the control unit 108 has a configuration of a learning control unit 116 to be described later, and model learning processing is performed by the learning control unit 116. Therefore, the common configurations and processing are denoted by the same reference numerals, and with no description given of such configuration and processing, the following description mainly focuses on differences.

### <Vehicle Configuration>

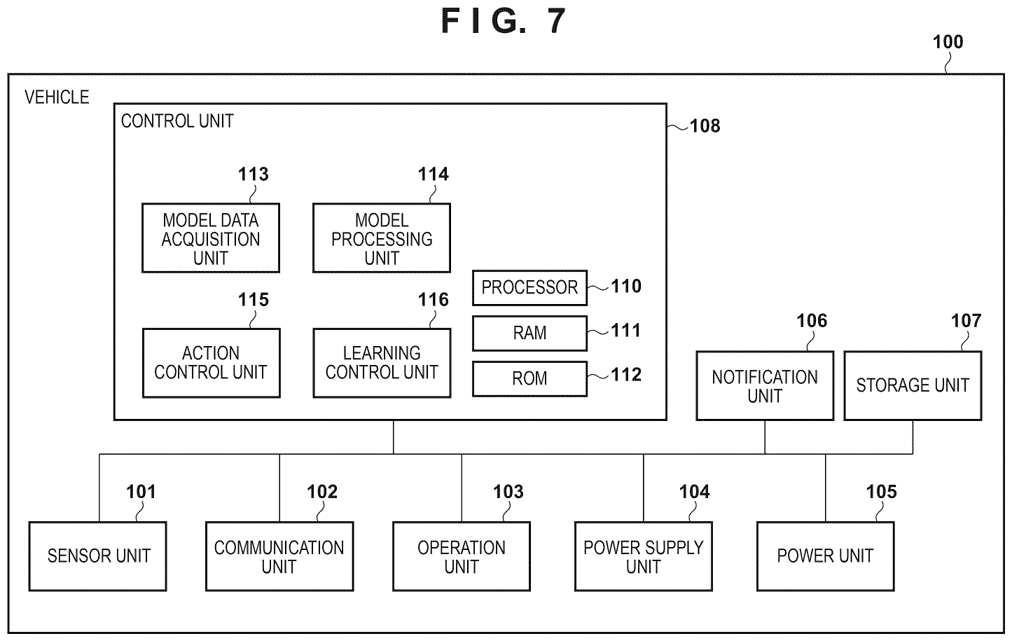

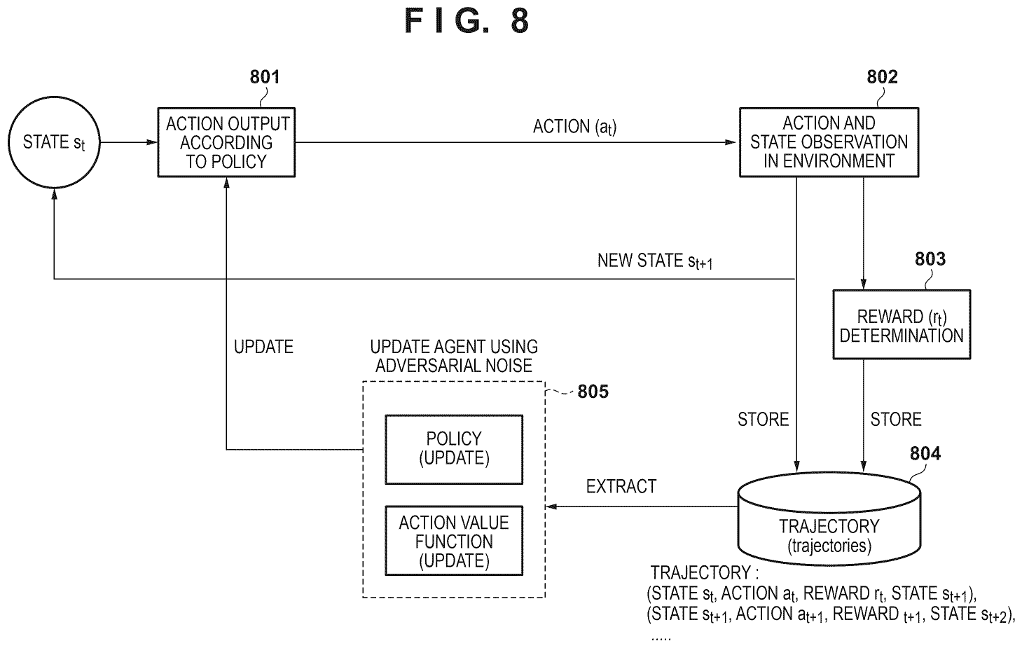

The configuration of the vehicle according to the second embodiment will be described with reference to FIG. 7. In the present embodiment, the control unit 108 includes the learning control unit 116. The learning control unit 116 trains a model by, for example, reinforcement learning illustrated in FIG. 8. Note that, in the description of the present embodiment, for example, a case where a reinforcement learning model constituting Actor-Critic is used will be described as an example, but another reinforcement learning model may be used. Training of the reinforcement learning model executed by the learning control unit 116 will be described later.

FIG. 8 illustrates a learning method of off-policy reinforcement learning as an example of the reinforcement learning. In the off-policy reinforcement learning, action output 801 according to a policy, action and state observation in environment 802, and reward determination 803 are repeated a predetermined number of times. The learning control unit 116 stores, in the storage unit 107, for example, time-series data (trajectory 804) obtained by collecting a plurality of sets of states, actions, rewards, next states, and the like obtained by the repetition. The learning control unit 116 extracts the stored trajectory, updates an action value function, and then updates a policy function. The learning control unit 116 repeats the update of the action value function and the update of the policy function, and updates a policy function of the model used in the model processing unit 114 with the trained policy function when the learning is completed. Noise addition processing according to the present embodiment is used in the update of the action value function that is repeatedly executed.

### <Operation of Model Learning Processing>

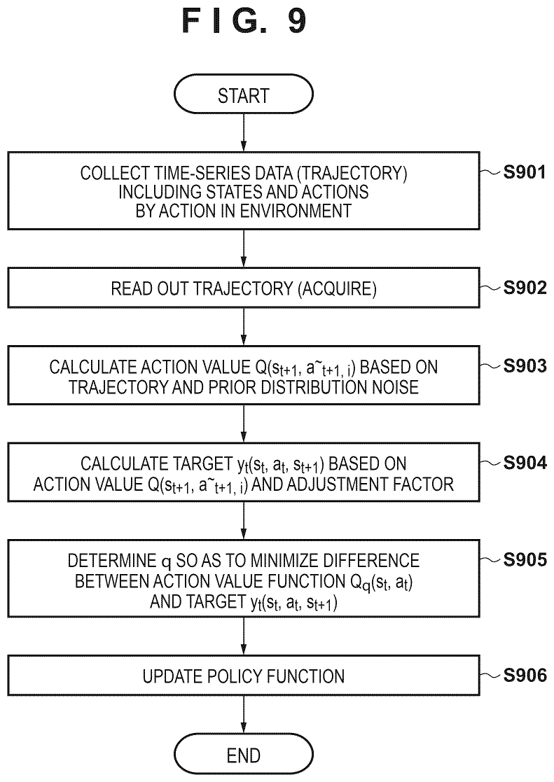

A series of operations of the model learning processing in the learning control unit 116 will be described with reference to FIG. 9. Note that the model learning processing is implemented, for example, by the processor 110 deploying a computer program stored in the ROM 112 or the storage unit 107 to the RAM 111 and executing the computer program. The learning control unit 116 performs the following processing as a processing entity unless otherwise specified.

In S901, the learning control unit 116 collects time-series data (trajectory) including states and actions by action and state observation in an environment. The learning control unit 116 repeats the action and state observation in the environment a predetermined number of times. In addition, the learning control unit 116 stores the collected trajectory in the storage unit 107, for example.

In S902, the learning control unit 116 reads the stored trajectory. In S903, the learning control unit 116 calculates an action value Q(sₜ₊₁, a^{˜}ₜ₊₁) similarly to the first embodiment based on the trajectory and a distribution approximating adversarial noise.

In S904, the learning control unit 116 calculates a target yₜ(sₜ, aₜ, sₜ₊₁) based on the action value Q(sₜ₊₁, a^{˜}ₜ₊₁) and the adjustment factor αₐₜₜₖ. Specifically, in the case of using a sample approximation, noise of n next states is acquired from the prior distribution p, that is, s^{˜}_{t+1,i}˜p(·|sₜ₊₁) (where, i=1, 2, . . . , and n) is obtained and an action taken under the noise, that is, a^{˜}_{t+1,i}˜π(⋅|s^{˜}_{t+1,i}) is acquired according to a policy (controller). In this case, the learning control unit 116 calculates the target yₜ(sₜ, aₜ, sₜ₊₁) according to the following Formula (6). In Formula (6), r(sₜ, aₜ) represents a reward, and y represents a discount reward. A term of an estimate of an action value in a next state on the right side of Formula (6) is a value of the action value obtained as a result of substituting Formula (2), which is an analytical solution, into a term inside argmin on the right side of Formula (1). This term is the estimate of the action value in the next state in consideration of the adversarial noise, and has a form in which a larger weight is added as the action value decreases under the noise. Here, the way of adding the weight becomes more extreme as αₐₜₜₖ is smaller, and average addition is performed as attk is larger.

In addition, in a case where an adversarial perturbation model v^{model}_{π}(s^{˜}ₜ₊₁|sₜ₊₁) approximated in the first embodiment is used, sₜ₊₁ is input to the adversarial perturbation model based on Formula (7) to directly calculate an adversarial perturbation s^{˜}ₜ₊₁ of the next state and calculate the target yₜ(sₜ, aₜ, sₜ₊₁).

In S905, the learning control unit 116 determines a parameter θ of the action value function Q so as to minimize a difference between an action value function Q_{θ}(sₜ, aₜ) and the target yₜ(sₜ, aₜ, sₜ₊₁) according to Formula (5). Here, “sₜ, aₜ, sₜ₊₁˜D(⋅)” means that a plurality of trajectories are extracted from the storage unit 107 by the size of a batch to calculate an expected value.

$$[ MATH . 5 ]$$

$$L ( Q ) = {E}_{{s}_{t} , {a}_{t} , {s}_{t + 1} ∼ D ( \cdot )} [ {\vert y ( {s}_{t} , {a}_{t} , {s}_{t + 1} ) - {Q}^{π} ( {s}_{t} , {a}_{t} ) \vert}^{2} ] \qquad ( 5 )$$

$$[ MATH . 6 ]$$

$$y ( {s}_{t} , {a}_{t} , {s}_{t + 1} ) = r ( {s}_{t} , {a}_{t} ) + γ [ - {α}_{attk} log ( \frac{1}{N} {\sum }_{i = 1}^{n} exp ( \frac{- {Q}^{π} ( {s}_{t + 1} , {a}_{t + 1 , i}^{\sim} )}{{α}_{attk}} ) ) ] \qquad ( 6 )$$

$$[ MATH . 7 ]$$

$$y ( {s}_{t} , {a}_{t} , {s}_{t + 1} ) = r ( {s}_{t} , {a}_{t} ) + γ {E}_{{s}_{t + 1}^{\sim} \sim {v}_{π}^{model ( \cdot \vert {s}_{t + 1} )}} [ {E}_{{a}_{t + 1}^{\sim} ∼ π ( \cdot \vert {s}_{t + 1}^{\sim} )} [ {Q}^{π} ( {s}_{t + 1} , {a}_{t + 1}^{\sim} ) ] ] \qquad ( 7 )$$

In S906, the learning control unit 116 updates a policy function. For example, in a case where the calculation is performed using the sample approximation, the learning control unit 116 updates the policy function such that a result of an action in a state to which the adversarial noise is added maximizes the action value according to Formulas (8) and (9). Specifically, a weighting factor w, obtained by taking n samples from the prior distribution p(i=1, 2, . . . , and n) and then correcting (dividing) the weight of the prior distribution from the adversarial perturbation expressed by Formula (2), is used. Here, in the case where the adversarial perturbation model v^{model}_{π}(s^{˜}ₜ|sₜ) approximated in the first embodiment is used, the state sₜ is input to the adversarial perturbation model using Formula (10) to directly calculate the adversarial perturbation sₜ, and the policy function is updated so as to maximize the action value based on the adversarial perturbation s^{˜}ₜ. Here, sₜ˜D(⋅) mean that a plurality of current states sₜ are extracted from the storage unit 107 by the size of a batch to calculate an expected value.

$$[ MATH . 8 ]$$

$$J ( π ) = {E}_{{s}_{t} ∼ D ( \cdot )} [ {\sum }_{i = 1}^{n} w ( {s}_{t , i}^{\sim} , {s}_{t} ) {E}_{{a}_{t , i}^{\sim} ∼ π ( \cdot \vert {s}_{t , i}^{\sim} )} [ {Q}^{π} ( {s}_{t} , {a}_{t , i}^{\sim} ) ] ] \qquad ( 8 )$$

$$[ MATH . 9 ]$$

$$w ( {s}_{t , i}^{\sim} , {s}_{t} ) ∝ exp ( {E}_{{a}_{t , i}^{\sim} ∼ π ( \cdot \vert {s}_{t , i}^{\sim} )} [ \frac{- {Q}^{π} ( {s}_{t} , {a}_{t , i}^{\sim} )}{{α}_{attk}} ] ) \qquad ( 9 )$$

$$[ MATH . 10 ]$$

$$J ( π ) = {E}_{{s}_{t} ∼ D ( \cdot )} [ {E}_{{s}_{t}^{\sim} \sim {v}_{π}^{model} ( \cdot \vert {s}_{t} )} [ {E}_{{a}_{t}^{\sim} ∼ π ( \cdot \vert {s}_{t}^{\sim} )} [ {Q}^{π} ( {s}_{t} , {a}_{t}^{\sim} ) ] ] ] \qquad ( 10 )$$

When the policy function is optimized, the learning control unit 116 updates the policy of the model processing unit 114, and then terminates the present processing.

As described above, in the present embodiment, the adversarial noise described in the first embodiment is used at the time of training the reinforcement learning model. That is, the learning control unit 116 optimizes the action value function of the model to be processed based on a predetermined prior distribution and the action value of the action in the perturbed state obtained by adding the adversarial noise to the state in the environment used in the model to be processed. At this time, the noise addition unit 113 determines the distribution of the adversarial noise under a constraint using a divergence representing the closeness between the distribution of the adversarial noise and the predetermined prior distribution. In this manner, it is possible to add appropriate noise for ensuring the robustness of the model, and it is possible to train a model of which the robustness and performance have been ensured according to the assumed noise (prior) distribution and the degree to which the noise is adversarial.

### Third Embodiment

Next, a third embodiment will be described. In the first embodiment and the second embodiment, a case where adversarial noise is added to a state in reinforcement learning (a case where noise is added to observed data) has been described. In the third embodiment, a case where it is difficult for a model to output a correct result due to a perturbation of an environment in reinforcement learning will be described. Note that processing inside the noise addition unit 113, the model processing unit 114, and the learning control unit 116 is different in the third embodiment, but other configurations and processing are substantially the same as those of the above-described embodiments. Therefore, the common configurations and processing are denoted by the same reference numerals, and with no description given of such configuration and processing, the following description mainly focuses on differences.

### <Evaluation of Reinforcement Learning Model>

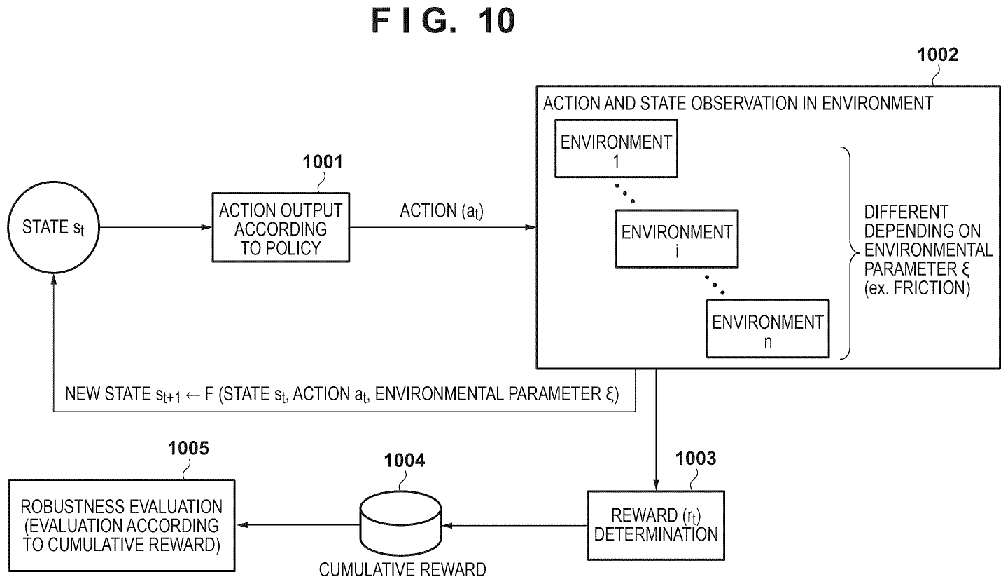

Evaluation of a reinforcement learning model according to the present embodiment will be described with reference to FIG. 10. At certain time t, sensor data is acquired. When the sensor data is acquired, the model processing unit 114 receives the sensor data and outputs a control amount that has been obtained (by execution of a machine learning algorithm) (action output according to policy 1001). At this time, in reinforcement learning, the sensor data corresponds to the state (sₜ) of an environment, and the control amount corresponds to the action (aₜ) with respect to the environment.

The environment is distinguished as {Environment 1, . . . , Environment i, . . . , and Environment n} based on a difference in an environmental parameter ξ (for example, friction). Although being described in the form of an environment i for the sake of description, environmental parameters can be handled as continuous variables such as friction coefficients, or can be handled as discrete parameters such as vehicle types of vehicles to be controlled. In addition, even in a plurality of combinations thereof, ξ can be considered as a vector to be handled in the same manner. In the present embodiment, the environmental parameters are assumed to follow a predetermined prior distribution. The model processing unit 114 acquires the prior distribution from the storage unit 107 or the communication unit 102. The prior distribution may be various distributions assuming a distribution of environmental parameters that can occur in an environment used in a model to be evaluated, and various distributions can be used in addition to a normal distribution. When a machine learning model takes the action aₜ in environments, the state transitions to a new state sₜ₊₁ by different dynamics F (state sₜ₊₁|state sₜ, action aₜ; environmental parameter ξ) (action and state observation in environment 1002). At this time, when the model processing unit 114 selects an environment in which an action value Q(state sₜ, action aₜ; environmental parameter ξ) of the machine learning model is the lowest, the environment that is the weakest for the reinforcement learning model is given. That is, if the model processing unit 114 selects an environment in which the action value Q(state sₜ, action aₜ; environmental parameter ξ) of the machine learning model is the lowest and then determines the reward rₜ of the model in the environment (reward determination 1003), robustness is evaluated in an adversarial environment.

As time elapses, the processing from 1001 to 1003 is repeated, and rewards for actions over a plurality of steps are accumulated (cumulative reward 1004). For example, the model processing unit 114 compares a cumulative reward obtained in a non-adversarial environment with the cumulative reward 1004 to evaluate the robustness with respect to the model (robustness evaluation 1005). For example, in a case where the cumulative reward 1004 has changed by a predetermined value or more from the cumulative reward in the non-adversarial environment, it means that an action of the model deviates from an originally expected action, which indicates that the robustness with respect to the adversarial environment is low.

### <Change in Environment>

Next, a change in an environment according to the present embodiment will be described. In this processing, when the action aₜ in the state sₜ acquired at time t is determined, the model processing unit 114 uses the environmental parameter ξ in the action value function Q(sₜ, aₜ; ξ) and an adversarial distribution v(ξ|sₜ, aₜ) in which an objective function obtained by adding a constraint of a f-divergence is minimized, that is, a distribution according to Formula (11).

$$[ MATH . 11 ]$$

$${v}^{*} ( ξ \vert {s}_{t} , {a}_{t} ) = {arg min}_{v ∈ N} {E}_{ξ ∼ v} [ {Q}^{π} ( {s}_{t} , {a}_{t} ; ξ ) ] + {α}_{attk} {D}_{f} ( v ( \cdot \vert {s}_{t} , {a}_{t} ) ‖ p ( \cdot ) ) \qquad ( 11 )$$

Here, D_{f}(v∥p) is the f-divergence between the adversarial distribution v and the prior distribution p of the environmental parameters, and αₐₜₜₖ is an adjustment factor for adjusting the strength of the constraint by the divergence. That is, how much the adversarial distribution v of the environment is constrained to the prior distribution p can be adjusted by αₐₜₜₖ.

As a value of αₐₜₜₖ is closer to 0, a distribution of v*(ξ|sₜ, aₜ) can approach a spike-like distribution having a peak at one environmental parameter that minimizes the action value, as an example. On the other hand, as the value of αₐₜₜₖ is larger, the distribution of v*(ξ|sₜ, aₜ) closer to the distribution of the prior distribution p is generated. That is, in the present embodiment, if the value of αₐₜₜₖ is appropriately set, it is possible to obtain the adversarial distribution adjusted to have characteristics of the prior distribution p while including the characteristics of the adversarial distribution of the environment (that minimizes the action value).

Next, when the divergence is assumed to be KL divergence, an analytical solution of Formula (12) is obtained by the Legendre-Fenchel Transform of Formula (11) of the minimized adversarial distribution v*(ξ|sₜ, aₜ).

$$[ MATH . 12 ]$$

$${v}_{π}^{*} ( ξ \vert {s}_{t} , {a}_{t} ) = \frac{p ( ξ ) exp ( - {Q}^{π} ( {s}_{t} , {a}_{t} ; ξ ) / {α}_{attk} )}{{\int }_{ξ} p ( ξ ) exp ( - {Q}^{π} ( {s}_{t} , {a}_{t} ; ξ ) / {α}_{attk} ) d ξ} \qquad ( 12 )$$

Here, similarly to the first embodiment, approximation as in Formula (13) can be performed by sampling a limited number (i=1, 2, . . . , and n) from the prior distribution p(ξ) and subtracting a probability weight from Formula (12) for correction.

$$[ MATH . 13 ]$$

$${v}^{*} ( ξ \vert {s}_{t} , {a}_{t} ) ≅ {v}^{*} ( {ξ}_{i} \vert {s}_{t} , {a}_{t} ) ∝ exp ( \frac{- {Q}^{π} ( {s}_{t} , {a}_{t} ; {ξ}_{i} )}{{α}_{attk}} ) \qquad ( 13 )$$

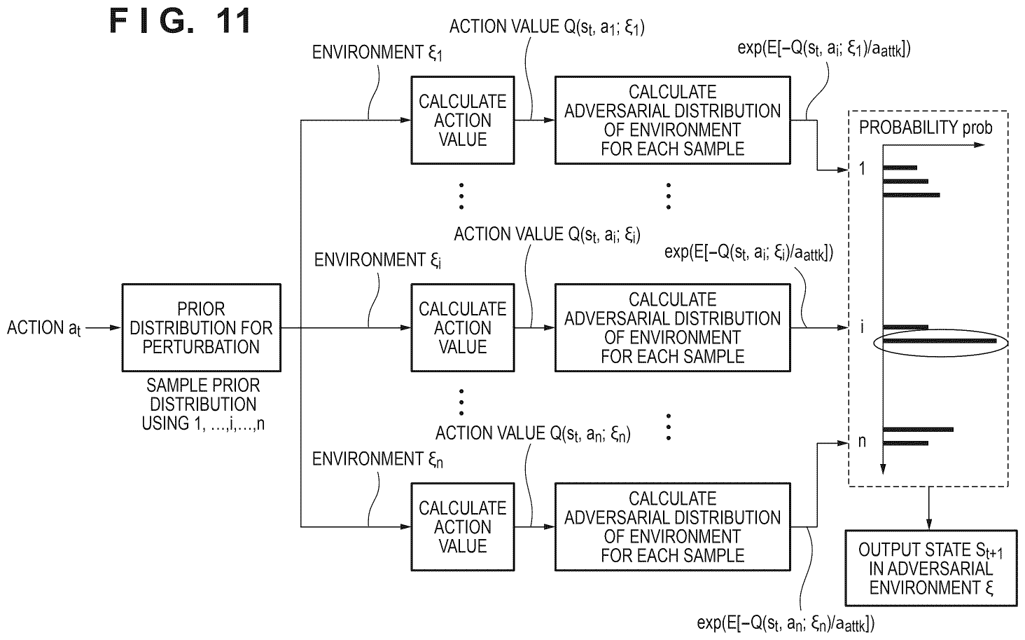

This corresponds to calculating the action values Q(sₜ, ai; ξᵢ) corresponding to samples illustrated in FIG. 11, and then calculating the adversarial noise distribution for the samples. Specifically, the adversarial distribution is obtained by calculating an exponential function using a ratio between the action value Q(sₜ, ai; ξᵢ) and a value of the adjustment factor dank as a variable.

In addition, as another approximation unit, an adversarial environmental parameter distribution model v^{model}_{π}(ξ|sₜ, aₜ) for a parameterized environment can be separately prepared and trained so as to match Formula (12) that is the analytical solution. Similarly to the first embodiment, this can be easily achieved by updating the adversarial environmental parameter distribution so as to minimize the model and Formula (14) of the KL divergence on the right side of Formula (12).

$$[ MATH . 14 ]$$

$$Loss = {E}_{{s}_{t} , {a}_{t} ∼ D ( \cdot )} [ {D}_{KL} ( {v}_{π}^{model} ( \cdot \vert {s}_{t} , {a}_{t} ) \vert \frac{p ( \cdot ) exp ( - {Q}^{π} ( {s}_{t} , {a}_{t} ; \cdot ) / {α}_{attk} )}{Z} ) ] ∝ {E}_{{s}_{t} , {a}_{t} ∼ D ( \cdot )} [ {E}_{ξ \sim {v}_{π}^{model} ( \cdot \vert {s}_{t} , {a}_{t} )} [ \text{} {α}_{attk} log {v}_{π}^{model} ( ξ \vert {s}_{t} , {a}_{t} ) - {α}_{attk} log p ( ξ ) + {Q}^{π} ( {s}_{t} , {a}_{t} ; ξ ) + const . ] ] \qquad ( 14 )$$

Similarly to the above-described embodiments, in approximation by sampling, an approximate adversarial distribution v*(sₜ, ai; ξᵢ) according to Formula (13) is calculated based on the action value Q(ξ|sₜ, aₜ) corresponding to a perturbation obtained by sampling the prior distribution. In a case where the adversarial environmental parameter distribution model is used, the adversarial distribution is calculated directly from the model. Therefore, it is not necessary to perform optimization calculation regarding the action value using a gradient method. Since the optimization calculation using the gradient method that requires a large calculation cost becomes unnecessary, the calculation cost can be greatly reduced, and the processing speed can be increased.

The model processing unit 114 selects the environmental parameter ξ according to the probability weight according to Formula (12) from the obtained adversarial distribution in the case of approximation by sampling or from an approximated output distribution in the case of approximation by the adversarial environmental parameter distribution model, and uses the state sₜ₊₁ that transitions according to the environment. Here, the (weakest and most adversarial) environment having the lowest action value is selected when the adjustment factor αₐₜₜₖ is small, that is, when αₐₜₜₖ→0, and the environment is selected according to the distribution p(ξ) of the environmental parameters assumed in advance when αₐₜₜₖ is sufficiently large. In this manner, it is possible to select an appropriate environment for evaluating the robustness necessary for the model while following the distribution assumed in advance.

Note that, in a case where the approximation by sampling is performed in the present embodiment, characteristics of robustness evaluation according to the magnitude of the number of samples are similar to those in the above-described embodiments. That is, a user can evaluate a reasonable model by adjusting the number of samples according to the evaluation purpose. Even when the occurrence frequency of the most adversarial environment is extremely low, a model is evaluated by sufficiently increasing the number of samples in a case where the evaluation of robustness of the model using the environment is required. On the other hand, in a case where it is sufficient to perform evaluation in an environment according to the characteristics of the prior distribution and the evaluation in an environment whose occurrence frequency is extremely low is not necessarily required, a model can be evaluated by reducing the number of samples. Of course, in this case, the model evaluation can be performed at high speed.

### <Operation of Robustness Evaluation Processing>

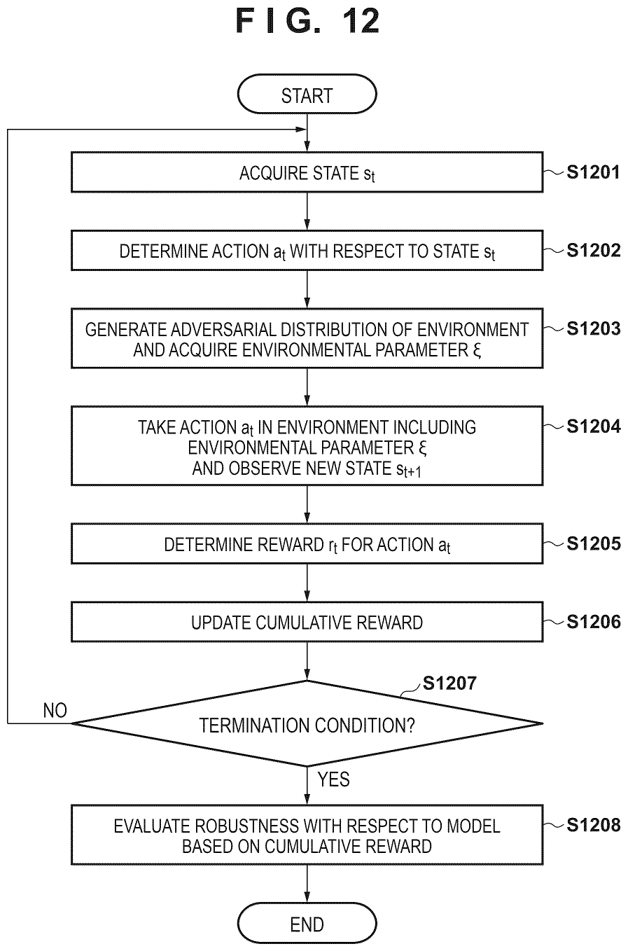

Next, a series of operations of robustness evaluation processing will be described with reference to FIG. 12. Note that this processing is implemented, for example, by the processor 110 deploying a computer program stored in the ROM 112 or the storage unit 107 to the RAM 111 and executing the computer program. The model processing unit 114 performs the following processing as a processing entity unless otherwise specified.

In S1201, the control unit 108 acquires sensor data from the sensor unit 101 at time t and acquires the state sₜ of an environment used in a target reinforcement learning model.

In S1202, the model processing unit 114 determines the action aₜ in the state sₜ according to, for example, the policy x of the actor.

In S1203, the model processing unit 114 generates an adversarial distribution of the environment, for example, by executing the processing described above in FIG. 11, and acquires (selects) the (for example, most adversarial) environmental parameter ξ.

In S1204, the model processing unit 114 takes the action aₜ in the environment including the environmental parameter ξ (for example, outputs a control amount corresponding to the action aₜ) and acquires a new state sₜ₊₁.

The model processing unit 114 determines a reward rₜ for the action aₜ in S1205, and updates a cumulative reward in S1206. In S1207, the model processing unit 114 determines whether a termination condition is satisfied, advances the processing to S1208 if the termination condition is satisfied, and returns the processing to S1201 to repeat the processing if not. When repeating the processing, the model processing unit 114 advances the time from t to t+1. The termination condition may be any condition, but may be, for example, a case where the time t exceeds a predetermined time T or the like.

In S1208, for example, the model processing unit 114 compares a cumulative reward obtained in a case where an environment serving as an evaluation criterion is selected (for example, in a case where a non-adversarial environment is selected) with the cumulative reward in S1206, and evaluates robustness with respect to the model. As described above, for example, in a case where the cumulative reward in S1206 has changed by a predetermined value or more from the cumulative reward in a case where the adversarial environment is not selected, it is determined that the robustness with respect to the adversarial environment is low. Thereafter, the model processing unit 114 terminates the present processing.

### <Model Learning Processing Using Adversarial Distribution of Environment>

Next, an example in which a model is trained using the adversarial distribution of the environment described in the third embodiment will be described. By training the model using the adversarial environment, robustness of the trained model can be improved. The training of the model by the learning control unit 116 can be performed substantially in the same manner as the processing described in FIG. 8.

That is, in learning of the action value function, the model is updated such that the target y coincides with the action value function as shown in Formula (15). Here, “sₜ, aₜ˜D(⋅)” means that a plurality of trajectories are extracted from the storage unit 107 by the size of a batch to calculate an expected value.

In a case where the approximation by sampling is performed, a finite number of samples ξᵢ (here, n (i=1, 2, . . . , and n)) are acquired from the predetermined prior distribution p of the environmental parameters, and a next state s_{t+1,i} is calculated using an environment model T(sₜ₊₁|sₜ, aₜ, ξ) using the environmental parameters ξᵢ, the state sₜ, and the action aₜ. The next state s_{t+1,i} can be directly calculated when a known environment model T such as a simulator is used for a learning environment, and can be easily calculated by training a prediction model from a plurality of pieces of trajectory data sₜ, aₜ, and sₜ₊₁ stored in the storage unit 107 even in an unknown environment. The target y is calculated by Formula (16) based on pieces of the acquired information, and the action value function is updated by Formula (15).

In addition, in a case where the adversarial distribution of the environmental parameter is approximated by the model as shown in Formula (14), the target y can be calculated by directly obtaining the environmental parameter ξ from the adversarial environmental parameter distribution model as expressed by Formula (17).

$$[ MATH . 15 ]$$

$$L ( Q ) = {E}_{{s}_{t} , {a}_{t} ∼ D ( \cdot )} [ {\vert y ( {s}_{t} , {a}_{t} ) - {Q}^{π} ( {s}_{t} , {a}_{t} ; ξ ) \vert}^{2} ] \qquad ( 15 )$$

$$[ MATH . 16 ]$$

$$y ( {s}_{t} , {a}_{t} ) = r ( {s}_{t} , {a}_{t} ) + γ [ - {α}_{attk} log ( \frac{1}{N} {\sum }_{i = 1}^{n} exp ( \frac{- {Q}^{π} ( {s}_{t + 1 , i} , {a}_{t + 1 , i} ; {ξ}_{i} )}{{α}_{attk}} ) ) ] \qquad ( 16 )$$

$$[ MATH . 17 ]$$

$$y ( {s}_{t} , {a}_{t} ) = r ( {s}_{t} , {a}_{t} ) + γ {E}_{ξ ∼ {v}_{π}^{model} ( \cdot \vert {s}_{t} , {a}_{t} )} [ {E}_{{s}_{t + 1} ∼ T ( \cdot \vert {s}_{t} , {a}_{t} ; ξ )} [ {E}_{{a}_{t + 1} ∼ π ( \cdot \vert {s}_{t + 1} )} [ {Q}^{π} ( {s}_{t + 1} , {a}_{t + 1} ; ξ ) ] ] ] \qquad ( 17 )$$

Similarly, the update of the policy function will be described. In a case where the approximation by sampling is performed, similarly, finite samples (i=1, 2, . . . , and n, where n) are acquired from the predetermined prior distribution p(ξ), and the policy function is updated to maximize the action value function even under a perturbation of the environmental parameter by Formulas (18) and (19). Here, w is a weight correction term obtained by correcting the probability weight of the prior distribution p using the distribution on the right side of Formula (12) for the sampling, similarly to the above-described embodiments.

In addition, in a case where the adversarial distribution of the environmental parameter is approximated by the model as shown in the above Formula (14), the policy function can be updated by directly obtaining the environmental parameter ξ from the adversarial environmental parameter distribution model as expressed by Formula (20).

$$[ MATH . 18 ]$$

$$J ( π ) = {E}_{{s}_{t} ∼ D ( \cdot )} [ {E}_{{a}_{t} ∼ π ( \cdot \vert {s}_{t} )} [ {\sum }_{i = 1}^{n} w ( {ξ}_{i} \vert {s}_{t} , {a}_{t} ) {Q}^{π} ( {s}_{t} , {a}_{t} ; {ξ}_{i} ) ] ] \qquad ( 18 )$$

$$[ MATH . 19 ]$$

$$w ( {ξ}_{i} \vert {s}_{t} , {a}_{t} ) ∝ exp ( \frac{- {Q}^{π} ( {s}_{t} , {a}_{t} ; {ξ}_{i} )}{{α}_{attk}} ) \qquad ( 19 )$$

$$[ MATH . 20 ]$$

$$J ( π ) = {E}_{{s}_{t} ∼ D ( \cdot )} [ {E}_{{a}_{t} ∼ π ( \cdot \vert {s}_{t} )} [ {E}_{ξ ∼ {v}_{π}^{model} ( \cdot \vert {s}_{t} , {a}_{t} )} [ {Q}^{π} ( {s}_{t} , {a}_{t} ; ξ ) ] ] ] \qquad ( 20 )$$

At this time, in a case where the environmental parameter ξ does not change with the lapse of time, the same environmental parameter ξ can be used until the termination of the episode of learning. In this case, after the environmental parameter is selected by the processing described above with reference to FIG. 11, normal training of the reinforcement learning model may be performed using the same environmental parameter. That is, the learning control unit 116 trains the action value function and the policy function such that the action value of the action in the environment (specified by the selected environmental parameter) is maximized. In this manner, it is possible to train the model robust against the environment of the selected environmental parameter.

In addition, in a case where the environmental parameter ξ changes with a lapse of time (for example, friction of a road surface changes), the environmental parameter is selected by the processing described above in FIG. 11 for each time. In this manner, the model can be trained in the environment that changes from moment to moment due to the adversarial environmental parameter.

As described above, in the present embodiment, the control unit 108 determines the adversarial distribution of the environment based on the action value while adding the constraint using the divergence indicating the closeness between the adversarial distribution of the environment for the model to be evaluated and the predetermined prior distribution. In addition, the determined adversarial distribution of the environment is applied to a machine learning model to be evaluated, and robustness of the machine learning model to be evaluated is evaluated based on a change between a case where the adversarial environment is applied and a case where the adversarial environment is not applied. In this manner, it is possible to select an appropriate environment for evaluating the robustness of the model. In addition, the robustness of the model can be evaluated using the appropriate environment.

In addition, the selected adversarial environmental parameter is used at the time of training of the reinforcement learning model in the present embodiment. That is, the learning control unit 116 determines the adversarial distribution of the environment with respect to the model to be processed using the predetermined prior distribution, and optimizes the action value function of the model to be processed based on the action value of the action in the adversarial environment. In this manner, the model can be trained so as to be more robust against the adversarial environment. In other words, the appropriate environment for evaluating or ensuring the robustness of the model can be provided.

The invention is not limited to the foregoing embodiments, and various variations/changes are possible within the spirit of the invention.

What is claimed is:

1. An information processing apparatus comprising:
one or more processors; and
a memory storing instructions which, when the instructions are executed by the one or more processors, cause the information processing apparatus to:
determine a distribution of adversarial noise for a model to be processed using a predetermined prior distribution; and
train at least one of an action value function or a policy function of the model to be processed based on an action value of an action in a perturbed state obtained by adding the adversarial noise to a state in an environment used in the model to be processed,
wherein the instructions causing the information processing apparatus to determine the distribution of adversarial noise include the instructions causing the information processing apparatus to determine the distribution of the adversarial noise that reduces the action value of the model to be processed under a constraint using a divergence indicating closeness between the distribution of the adversarial noise and the predetermined prior distribution.

2. The information processing apparatus according to claim 1, wherein the instructions causing the information processing apparatus to determine the distribution of adversarial noise include the instructions causing the information processing apparatus to control a magnitude of the constraint by multiplying the divergence by an adjustment factor.

3. The information processing apparatus according to claim 1, wherein the divergence includes KL divergence.

4. The information processing apparatus according to claim 1, wherein the instructions causing the information processing apparatus to train the at least one of the action value function or the policy function of the model include the instructions causing the information processing apparatus to repeat processing for updating the action value function and the policy function of the model in order to train the action value function of the model.

5. The information processing apparatus according to claim 4, wherein the instructions causing the information processing apparatus to train the at least one of the action value function or the policy function of the model include the instructions causing the information processing apparatus to update the action value function of the model after the determination of the distribution of the adversarial noise.

6. The information processing apparatus according to claim 1, wherein the instructions causing the information processing apparatus to train the at least one of the action value function or the policy function of the model include the instructions causing the information processing apparatus, before training the action value function of the model, to store, in a storage medium, time-series data at a plurality of times obtained by repeating action and state observation in the environment and reward determination over a predetermined number of times.

7. The information processing apparatus according to claim 1, wherein the instructions further causes the information processing apparatus to set a number of samples for sampling of noise according to the predetermined prior distribution,
wherein the distribution of the adversarial noise is more likely to include noise that minimizes the action value of the model to be processed as the number of samples is larger, and the distribution of the adversarial noise is more likely to include the noise according to the predetermined prior distribution as the number of samples is smaller.

8. The information processing apparatus according to claim 1, wherein the instructions causing the information processing apparatus to determine the distribution of adversarial noise include the instructions causing the information processing apparatus to approximate the distribution of the adversarial noise with a modeled adversarial noise model.

9. The information processing apparatus according to claim 8, wherein the adversarial noise model is obtained by updating a parameter of the adversarial noise model using recorded trajectory data in such a way as to minimize a divergence between the distribution of the adversarial noise and an output distribution of the adversarial noise model.

10. The information processing apparatus according to claim 1, wherein the information processing apparatus is included in a vehicle or a robot.

11. The information processing apparatus according to claim 1, wherein the information processing apparatus is included in a server apparatus.

12. An information processing method in which each step is executed by an information processing apparatus, the information processing method comprising:
determining a distribution of adversarial noise for a model to be processed using a predetermined prior distribution; and
training at least one of an action value function or a policy function of the model to be processed based on an action value of an action in a perturbed state obtained by adding the adversarial noise to a state in an environment used in the model to be processed,
wherein the determining the distribution of the adversarial noise includes determining the distribution of the adversarial noise that reduces the action value of the model to be processed under a constraint using a divergence indicating closeness between the distribution of the adversarial noise and the predetermined prior distribution.

13. A non-transitory computer readable storage medium storing a program for causing a computer to execute an information processing method, the information processing method comprising:
determining a distribution of adversarial noise for a model to be processed using a predetermined prior distribution; and
training at least one of an action value function or a policy function of the model to be processed based on an action value of an action in a perturbed state obtained by adding the adversarial noise to a state in an environment used in the model to be processed,
wherein the determining the distribution of the adversarial noise includes determining the distribution of the adversarial noise that reduces the action value of the model to be processed under a constraint using a divergence indicating closeness between the distribution of the adversarial noise and the predetermined prior distribution.
